(19) United States
(12) Patent Application Publication
(10) Pub. No.: US 2025/0130767 A1
(43) Pub. Date: Apr. 24, 2025

(54) FLOATING-POINT CONVERSION CIRCUIT

(71) Applicant: Advanced Micro Devices, Inc., Santa Clara, CA (US)

(72) Inventors: Shubh Shah, Folsom, CA (US); Ashutosh Garg, Folsom, CA (US); Bin He, Orlando, FL (US); Michael Mantor, Orlando, FL (US); Shubra Marwaha, Santa Clara, CA (US); Subramaniam Maiyuran, Folsom, CA (US)

(73) Assignee: Advanced Micro Devices, Inc., Santa Clara, CA (US)

(21) Appl. No.: 18/921,401

(22) Filed: Oct. 21, 2024

Related U.S. Application Data
(60) Provisional application No. 63/591,966, filed on Oct. 20, 2023.

(51) Int. Cl. G06F 7/483

(52) U.S. Cl. CPC G06F 7/483

(57) ABSTRACT

The disclosed circuit can select micro-operations specifically for converting a value in a first number format to a second number format. The circuit can include micro-operations for various conversions between different number formats, including number formats of different floating-point precisions. Various other methods, systems, and computer-readable media are also disclosed.

### CROSS REFERENCE TO RELATED APPLICATION

This application claims the benefit of U.S. Provisional Application No. 63/591,966, filed 20 Oct. 2023, the disclosures of which is incorporated, in its entirety, by this reference.

### BACKGROUND

Floating-point numbers are commonly used by computing devices to represent a wide range of real number values for computations. Different floating-point number formats can be configured for various considerations, such as storage space/bandwidth considerations, computational considerations, mathematical properties, etc. Further, different computing devices can be configured to support different formats of floating-point numbers. As computing devices become more complex (e.g., having different types of hardware working in conjunction, using networked devices, etc.), and computing demands increase (e.g., machine learning models, particularly for fast decision making), support for different floating-point number formats can be desirable. Although software-based support for different floating-point number formats is possible, software support often incurs added latency or can otherwise be unfeasible for particular application requirements.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for floating-point conversion.

FIGS. 2A-C are diagrams of example floating-point number formats.

FIG. 3 is a simplified block diagram of a circuit for floating-point conversion.

FIG. 4 is a flow diagram of an exemplary method for floating-point conversion.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to floating-point conversion. As will be explained in greater detail below, implementations of the present disclosure perform a conversion of a value from a first number format to a second number format using processor instructions specific to the conversion. Using specific processor instructions advantageously allows faster and more efficient processing of values, which can further be incorporated into processing operations, and allows flexibility with supporting different number formats. In addition, the systems and methods provided herein can improve the technical field of machine learning by allowing improved accuracy (e.g., using number formats allowing higher accuracy operations) without sacrificing bandwidth (e.g., by switching to lower bandwidth number formats). Moreover, because conversion of formats is common in machine learning, the systems and methods provided herein can improve processing efficiency in various machine-learning contexts.

In one implementation, a device for hardware-based floating-point conversion includes a processing circuit configured to select, in response to receiving a value in a first number format of a plurality of number formats, a processor instruction for converting from the first number format to a second number format of the plurality of number formats, wherein the processor instruction is selected from a processor instruction set including processor instructions for converting between each pairing from amongst the plurality of number formats, and convert, using the selected processor instruction, the value from the first number format to the second number format.

In some examples, the processing circuit is further configured to apply a rounding scheme during the conversion. In some examples, the processing circuit applies the rounding scheme during a conversion from a higher-precision number format to a lower-precision number format.

In some examples, the conversion is used in a processing workflow for an operation, the processing workflow includes performing the operation using the value in the second number format, converting a result of the operation from the second number format to the first number format, and outputting the converted result in the first number format.

In some examples, converting the result of the operation from the second number format to the first number format includes using a second processor instruction. In some examples, the second number format has a higher floating-point precision than a floating-point precision of the first number format. In some examples, a floating-point precision of the first number format differs from a floating-point precision of the second number format.

In one implementation, a system for hardware-based floating-point conversion includes a memory, a processor, and a processing circuit comprising a processor instruction set including processor instructions for converting between each pairing from amongst a plurality of number formats. The processing circuit can be configured to select, in response to receiving a value in a first number format of the plurality of number formats, a processor instruction from the processor instruction set for converting from the first number format to a second number format of the plurality of number formats, wherein the first number format has a first floating-point precision and the second number format has a second floating-point precision different than the first floating-point precision, and convert, using the selected processor instruction, the value from the first number format to the second number format.

In some examples, the second floating-point precision is lower than the first floating-point precision. In some examples, the processing circuit is further configured to apply a rounding scheme during the conversion. In some examples, the processor instruction is used in a processing workflow for an operation.

In some examples, the processing workflow includes performing the operation using the value in the second number format, converting a result of the operation from the second number format to the first number format, and outputting the converted result in the first number format. In some examples, converting the result of the operation from the second number format to the first number format includes using a second processor instruction. In some examples, the second floating-point precision is higher than the first floating-point precision.

In one implementation, a method for hardware-based floating-point conversion includes (i) receiving a value in a first number format of a plurality of number formats, the first number format having a first floating-point precision, (ii) identifying a second number format from the plurality of number formats having a second floating-point precision different than the first floating-point precision, (iii) selecting a processor instruction for converting from the first number format to the second number format, wherein the processor instruction is selected from a processor instruction set including processor instructions for converting between each pairing from amongst the plurality of number formats, and (iv) converting, using the selected processor instruction, the value to the second number format.

In some examples, the method further includes processing the value in the second number format to produce an output value in the second number format, converting, using a second processor instruction configured to convert values from the second number format to the first number format, the output value to the first number format, and outputting the converted output value.

In some examples, the second floating-point precision is higher than the first floating-point precision. In some examples, the first floating-point precision is higher than the second floating-point precision. In some examples, the processor instruction is further configured to apply a rounding scheme for converting values from the first number format to the second number format.

Features from any of the implementations described herein can be used in combination with one another in accordance with the general principles described herein. These and other implementations, features, and advantages will be more fully understood upon reading the following detailed description in conjunction with the accompanying drawings and claims.

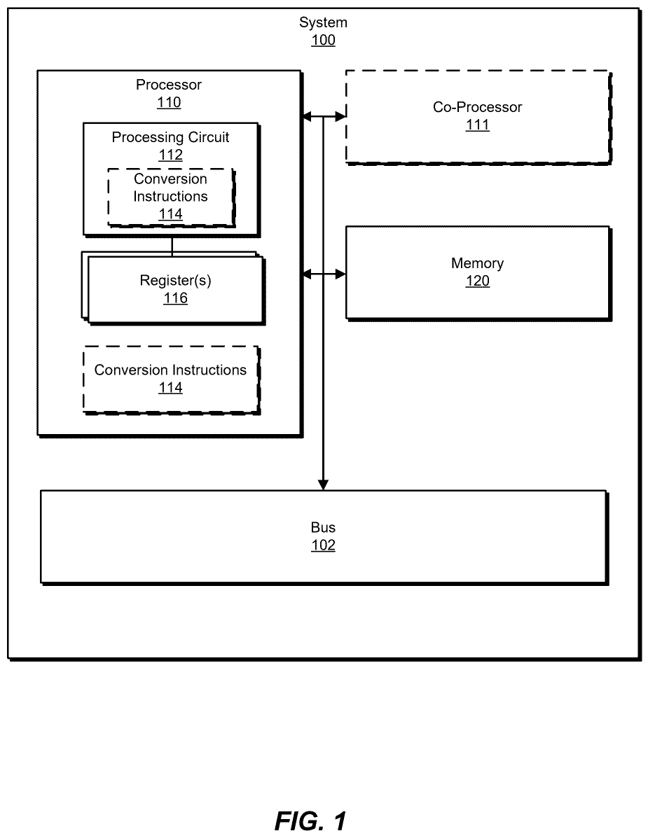

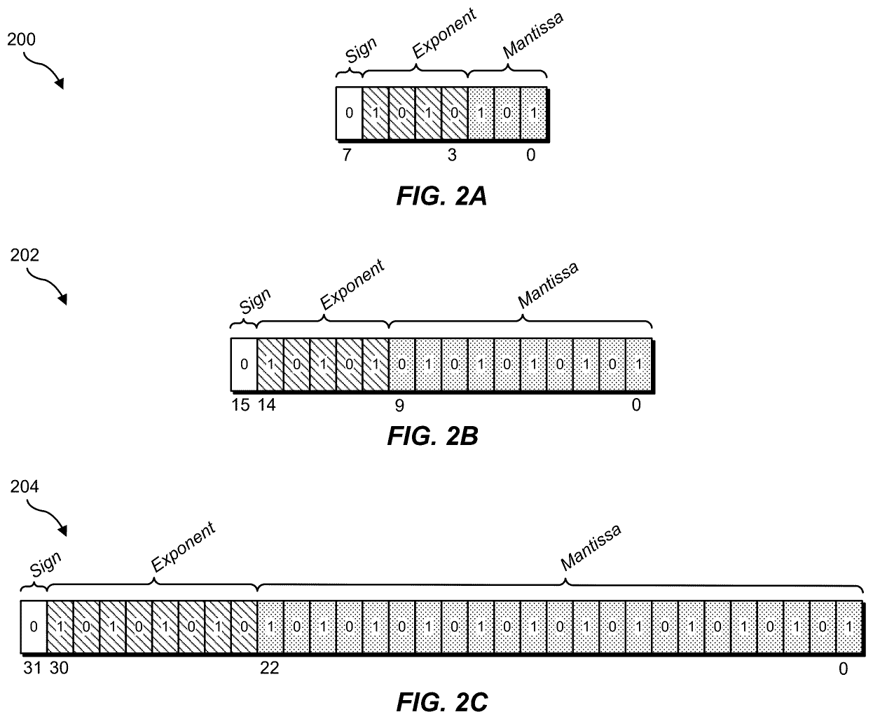

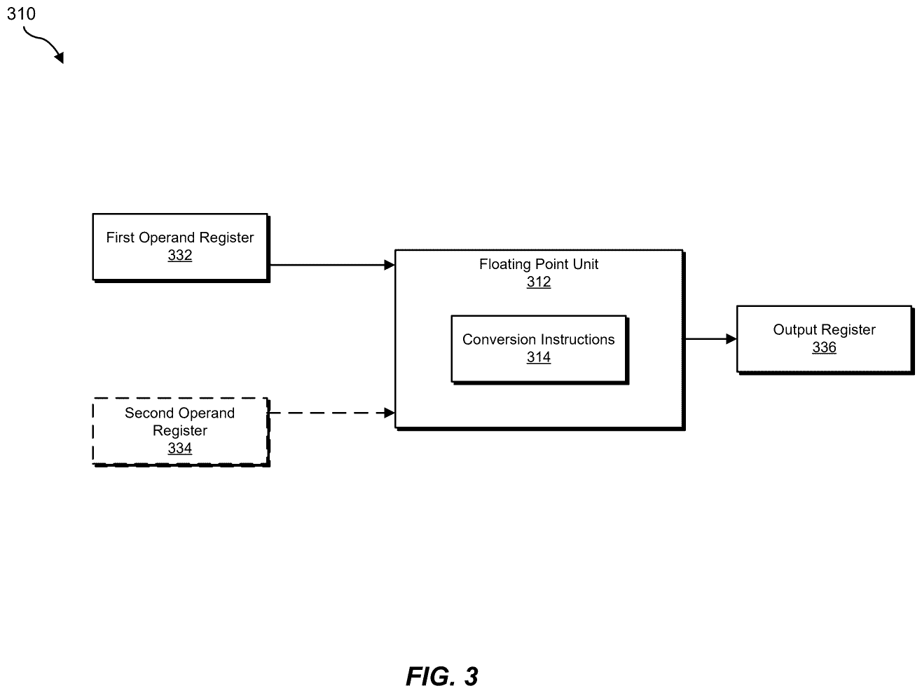

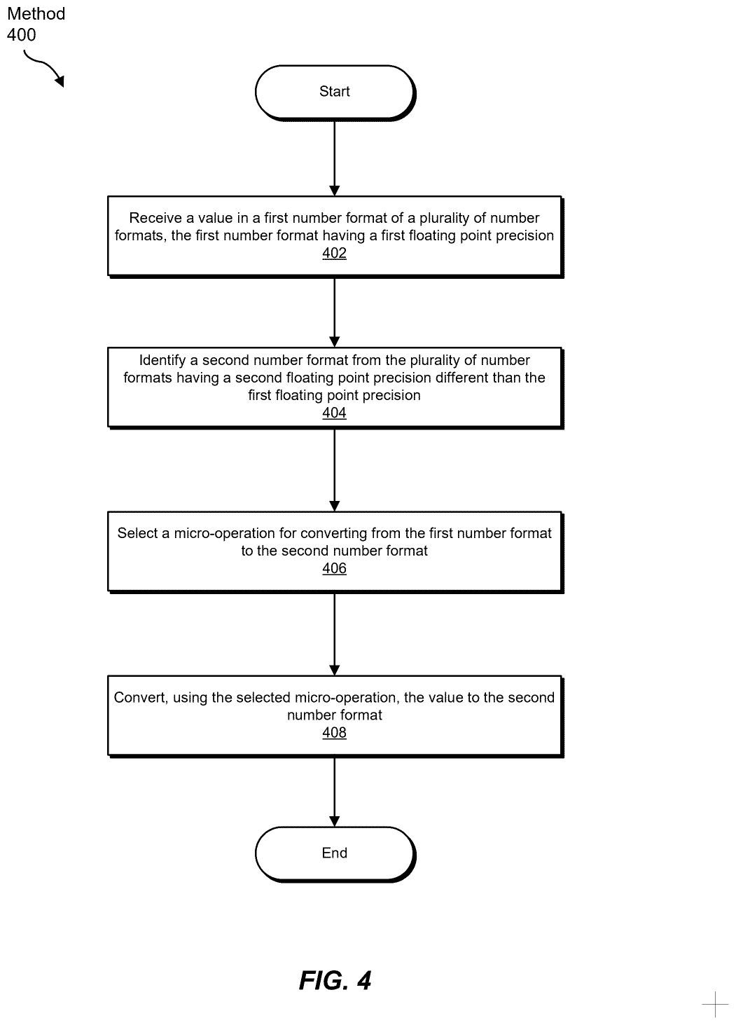

The following will provide, with reference to FIGS. 1-4, detailed descriptions of hardware-based floating-point conversion. Detailed descriptions of example systems and circuits will be provided in connection with FIGS. 1 and 3. Detailed descriptions of floating-point number formats will be provided in connection with FIGS. 2A-2C. Detailed descriptions of corresponding computer-implemented methods will also be provided in connection with FIG. 4.

FIG. 1 is a block diagram of an example system 100 for hardware-based conversion of floating-point numbers. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

In some implementations, the term “instruction” refers to computer code that can be read and executed by a processor. Examples of instructions include, without limitation, macro-instructions (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations correspond to the most basic operations achievable by a processor and therefore can further be organized into micro-instructions (e.g., a set of micro-operations executed simultaneously).

As further illustrated in FIG. 1, processor 110 includes a processing circuit 112, conversion instructions 114, and one or more register(s) 116. Processing circuit 112 corresponds to a processing component and in some examples includes circuitry and/or instructions for floating-point number conversion operations and/or portions thereof, and further in some examples can correspond to and/or interface with a floating-point unit (FPU) for performing floating-point operations. Conversion instructions 114 correspond to circuitry and/or instructions for converting values between different floating-point number formats, which can include floating-point number formats of a same or different floating-point precision. In some examples, conversion instructions 114 can be implemented as a circuit and/or instructions separate from and communicatively coupled to processing circuit 112. In other examples, conversion instructions 114 can correspond to or otherwise be implemented as firmware. In yet other examples, conversion instructions 114 can correspond to micro-operations that can be loaded and/or hard-wired into processing circuit 112. For instance, processing circuit 112 can be hard-wired with specific circuits configured to perform logic on bit values such that conversion instructions 114 can be implemented with such specific circuits. In other words, processing circuit 112 can be an integrated circuit configured to perform a set of operations that include conversion instructions 114. Register 116 represents a local storage of processor 110, such as for temporarily holding data for processing and can be implemented as one or more data holding circuits. In some implementations, processor 110 may include multiple iterations of register 116 (e.g., corresponding to multiple different physical registers, multiple different architectural registers mapped to one or more different and/or same physical registers, and/or combinations thereof). Processing circuit 112 can be communicatively coupled to register 116 such that processing circuit 112 can access (e.g., read/load and/or write/store) data from register 116. As will be described further below, processing circuit 112 can perform floating-point conversions directly, using values stored in register 116 as operands for conversion instructions 114.

FIGS. 2A-2C respectively illustrate a number format 200, a number format 202, and a number format 204, each corresponding to floating-point formats of different precisions (e.g., bit widths). For example, FIG. 2A illustrates an example 8-bit precision floating-point number format, FIG. 2B illustrates an example 16-bit precision floating-point number format, and FIG. 2C illustrates an example 32-bit precision floating-point number format.

A floating-point number corresponds to a real number value represented with significant digits and a floating radix point. For example, a decimal (real) number 432.1 can be represented, by moving (e.g., floating) the base-10 radix point (e.g., decimal point), as 4321*10\hat{ }−1, allowing a real number value to be represented by an integer (e.g., mantissa or significand) scaled by an integer exponent of a base. Because computing systems store bit sequences that are readily converted to binary (e.g., base 2) numbers, computing systems often use a base-2 radix point. For instance, 0.5 can be represented as 1*2\ddot{ }−1. Thus, in a binary representation of a floating-point number, a real number value, Value, can be represented by the following equation:

$$Equation 1$$

$$Value = {( - 1 )}^{Sign} * Normalized\_Mantissa * {2}^{Exponent - Bias}$$

Sign can indicate whether the value is positive (e.g., Sign=0) or negative (e.g., Sign=1). Normalized_Mantissa can correspond to a mantissa (e.g., as stored in a bit sequence) that has been normalized in accordance with a floating-point number format. A non-zero binary number can have its radix point floated such that its mantissa can always have a leading 1 (e.g., “1.01”). Accordingly, many floating-point number formats will not explicitly store this leading 1, as it is understood (e.g., when normalized). Exponent-Bias corresponds to the final exponent of the value after subtracting Bias from Exponent. Many floating-point number formats use a bias to avoid using a sign bit (e.g., for negative exponents), which can further allow efficient processing between two floating-point numbers. Thus, Exponent can correspond to the stored exponent value, and Bias can be a value defined for the specific floating-point number format. Further, floating-point number formats can define how bits in an allotted bit width can be decoded or interpreted. Thus, certain bits can be reserved for representing Sign, certain bits can be reserved for representing Exponent, and certain bits can be reserved for representing a Mantissa that can require normalizing.

Turning to FIG. 2A, number format 200 represents an example of an 8-bit floating-point number format (e.g., having an 8-bit width or precision such as quarter-precision). Number format 200 can define what each bit position of the 8-bit format represents. As illustrated in FIG. 2A, a single bit (e.g., bit 7) can correspond to a sign bit (e.g., Sign), four bits (e.g., bits 3-6 from least to most significant bits) can correspond to an exponent (e.g., Exponent), and three bits (e.g., bits 0-2 from least to most significant bits) can correspond to a mantissa. In other number formats, a number and/or order of bits for the various elements can vary. In addition, a bias (e.g., Bias) can be defined for number format 200. For example, the bias can be 7, corresponding to exponents ranging from −6 to 7, which are derived from subtracting the bias 7 from a range of 1-14 for the four bits (leaving “0” or all 0s and “15” or all 1s for special values). The bias can be based on the number of exponent bits. In some examples, the bias allows certain bit sequences (e.g., bit sequences having the exponent being all 0, as well as other particular bit sequences such as all 0, etc.) to represent special values (e.g., subnormal values, positive/negative zero, positive/negative infinity, undefined/not a number (NaN), etc.).

FIG. 2B illustrates number format 202 that represents an example of a 16-bit floating-point number format (e.g., half-precision). As illustrated in FIG. 2B, a single bit (e.g., bit 15) can correspond to a sign bit (e.g., Sign), five bits (e.g., bits 10-14 from least to most significant bits) can correspond to an exponent (e.g., Exponent), and ten bits (e.g., bits 0-9 from least to most significant bits) can correspond to a mantissa. The bias can be based on the number of exponent bits, such as 15, which can further reserve certain bit sequences as special values as described herein. In other examples, number format 202 can have different number and/or order of bits for the various elements.

FIG. 2C illustrates number format 204 that represents an examples of a 32-bit floating-point number format (e.g., single-precision). As illustrated in FIG. 2C, a single bit (e.g., bit 31) can correspond to a sign bit (e.g., Sign), eight bits (e.g., bits 23-30 from least significant to most significant bits) can correspond to an exponent (e.g., Exponent), and twenty-three bits (e.g., bits 0-22 from least significant to most significant bits) can correspond to a mantissa. The bias can be based on the number of exponent bits, such as 127, which can further reserve certain bit sequences as special values as described herein. In other examples, number format 204 can have different number and/or order of bits for the various elements.

In some examples, system 100 (e.g., processor 110) can be configured with circuitry and/or instructions for particular floating-point number formats. For example, certain elements of a number format (e.g., bias, special value sequences, etc.) can be incorporated into the circuitry and/or instructions without explicitly storing such elements in the floating-point number (e.g., bit sequence) itself. In some implementations, processor 110 can include circuitry and/or instructions for each supported floating-point number format (e.g., processing circuit 112 and/or conversion instructions 114 can correspond to multiple iterations).

However, it can be desirable to efficiently and, in some cases, repeatedly convert values between different formats. Processor 110 can receive and process data in different formats selected for prioritizing different features. For example, certain formats (e.g., higher floating-point precision formats that allow greater levels of precision in values) can be suitable for improved accuracy in calculations whereas certain other formats (e.g., lower floating-point precision formats that allow sending/storing more values) can be suitable for improved bandwidth and/or storage requirements. Moreover, devices are often configured to support a restricted set of formats, such as only one format per precision level. Processor 110 can interface with such devices for sending/receiving data in those formats.

FIG. 3 illustrates a processor 310 (corresponding to processor 110), that can perform operations directly with operands of different number formats. FIG. 3 includes a first operand register 332 (corresponding to an iteration of register 116 as an architectural register that can be mapped to a physical register), a second operand register 334 (corresponding to another iteration of register 116 as an architectural register that can be mapped to a physical register), an output register 336 (corresponding to yet another iteration of register 116 as an architectural register that can be mapped to a physical register), a floating-point unit 312 (corresponding to processing circuit 112), and conversion instructions 314 (corresponding to conversion instructions 114). In some examples, conversion instructions 314 can be hard-wired micro-operations in floating point unit 312 (e.g., such that floating point unit 312 can be an integrated circuit designed to perform operations on floating point numbers that include conversion instructions 314), although in other examples, the conversion instructions can be implemented separately (see, FIG. 1) and communicatively coupled to floating point unit 312.

First operand register 332 can be configured to load a value in a first floating-point number format. In some implementations, first operand register 332 can be configured to have data loaded from a first source, such as a particular device, component, and/or portion of memory. For example, processor 310 can be coupled to a storage device (e.g., memory 120, although in other examples can be a remote storage device) via a bus (e.g., bus 102 along with other interfaces and communication links as needed, such as for remote storage devices). Processor 310 can access the storage to read a desired data value and locally store the data value, such as directly loading the value into first operand register 332 and/or indirectly (e.g., from the storage device and loaded into another local storage such as a cache, another register, etc. and then copied into first operand register 332). Further, in some implementations, the first floating-point number format can be linked to the first source, although in other implementations the first floating-point number format can be identified when loaded. In some examples, second operand register 334 can be configured to have another value loaded in either the first floating-point number format or a second floating-point number format (which in some examples can have a higher or lower floating-point precision than a floating-point precision of the first floating-point number format).

Floating-point unit 312 can perform floating-point operations on the values stored in first operand register 332 and/or second operand register 334. Floating-point unit 312 can load or otherwise be hard-wired (e.g., as circuitry) with processor instructions (e.g., micro-operations) for performing various floating-point operations, such as arithmetic operations with floating-point numbers as operands. As described herein, floating-point unit 312 can directly convert the values to desired formats.

When decoding a floating-point operation (e.g., instruction) into processor instructions (e.g., micro-operations), floating-point unit 312 can select appropriate micro-operations (e.g., conversion instructions 314) for the operation based on the first floating-point number format. In some examples, conversion instructions 314 can include or be selected from multiple sets of micro-operations corresponding to possible combinations of number formats for conversion therebetween. For example, floating-point unit 312 and/or processor 310 can include a processor instruction set having processor instructions, such as micro-operations and/or sets of micro-operations for all of the floating-point number formats that floating-point unit 312 can support. The processor instruction set can include processor instructions corresponding to every combination of selecting two formats (e.g., for converting from one to the other), which can further be applied to and/or associated with each supported floating-point operation. Accordingly, floating-point unit 312 can use an appropriate subset of micro-operations (e.g., conversion instructions 314) out of the total set of micro-operations (e.g., that represent all of the possible combinations of formats) to directly convert the values from first operand register 332 and/or second operand register 334 without explicitly requiring an intermediary conversion operation. In other words, rather than having to explicitly include program code for converting data in one format into another format, floating-unit 312 can accept values in one or more formats, automatically convert into a second format (e.g., having higher precision), perform the desired floating-point operation with values in the second format (e.g., using the higher precision to allow for a higher precision result), and optionally convert the result into the initial format or another format for outputting. Floating-point unit 312 can operate as if the floating-point operation natively supported the initial formats. In other implementations (e.g., hard-wired), the floating-point operation can be implemented with a circuit specifically configured to perform the floating-point operation with various combinations of formats as described herein. For example, each combination of formats can have a corresponding a hard-wired circuit as part of floating-point unit 312.

The processor instructions (e.g., set of one or more micro-operations) can include micro-operations for converting a value (e.g., as a single operand). For instance, floating-point unit 312 can decode a conversion operation (e.g., a floating-point operation for converting a value) by selecting the appropriate micro-operations for the formats corresponding to the conversion operation. Floating-point unit 312 can convert, using appropriately selected conversion instructions 314, the value in first operand register 332 from the first floating-point number format into a desired second floating-point number format and store the converted result in output register 336. The second floating-point number format can be indicated by, for example, being associated with the specific conversion operation that was decoded, being linked to first operand register 332 and/or output register 336, a global indicator, a default format, and/or as a value in second operand register 334.

In some examples, the conversion can involve a loss of precision (e.g., when converting from a higher-precision floating-point number format to a lower-precision floating-point number format). In such examples, conversion instructions 314 can include processor instructions for applying a rounding scheme that can be used for producing a close approximation of the original value to account for the loss of precision. In some examples, conversion instructions 314 can include the rounding scheme (e.g., as instructions for applying the rounding scheme). For instance, the rounding scheme itself can be encoded as or otherwise included as part of conversion instructions 314 rather than applied using a separate dedicated rounding circuit to allow for flexibility in using different rounding schemes. Conversion instructions 314 can be configured with processor instructions to apply one or more rounding schemes as desired rather than being limited by a hard-wired rounding scheme. For example, an explicit conversion operation can be associated with a particular rounding scheme (e.g., a particular instance of conversion instructions 314 including the particular rounding scheme). Alternatively, conversion instructions 314 can use a default rounding scheme that can be configurable.

In addition, the set of micro-operations (e.g., conversion instructions 314) can include micro-operations for completing floating-point operations as part of a processing workflow. For example, the processing workflow can include performing floating-point operations in higher-precision floating-point number formats (e.g., for better accuracy) and converting results to lower-precision floating-point number formats (e.g., for better bandwidth/storage utilization). To streamline this processing workflow, the micro-operations for conversion can be selected with micro-operations for performing other operations (e.g., floating-point arithmetic operations).

The processing workflow can include, in some examples, converting one or both values in first operand register 332 and second operand register 334 to desired floating-point number formats (e.g., the second floating-point number format, which can be the higher-precision floating-point number format) as needed, using micro-operations. Floating-point unit 312 can continue with performing the floating-point operation using the values in the second number format. Floating-point unit 312 can convert the result of the operation from the second floating-point number format to the first floating-point number format (e.g., the lower-precision floating-point number format) using appropriate micro-operations and output the converted result to output register 336. In some examples, floating-point unit 312 can track the first floating-point number format and the second floating-point number format during the processing workflow for selecting the appropriate micro-operations for converting from the second floating-point number format back to the first floating-point number format although in other example, floating-point unit 312 can reevaluate the floating-point number formats for conversion at the end of the processing workflow.

Although described as a single workflow (e.g., the corresponding floating-point operations having automatic format conversion as described above), in some examples floating-point unit 312 can store intermediary results (e.g., converted values) into registers and access the intermediary results to proceed with the workflow as needed. In some examples, conversion instructions 314 can be configured with processor instructions that directly operate and convert values without having to store intermediary values. In some examples, conversion instructions 314 can include micro-operations for normalizing signs, exponents, and mantissas of the two operands, further allowing combining the signs, exponents, and/or mantissas in accordance with the operation to produce an output result that can be stored in output register 336.

FIG. 4 is a flow diagram of an exemplary computer-implemented method 400 for hardware-based floating-point conversion. The steps shown in FIG. 4 can be performed by any suitable device, circuit, and/or computing system, including the system(s) illustrated in FIGS. 1 and/or 3. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein receive a value in a first number format of a plurality of number formats, the first number format having a first floating-point precision. For example, processing circuit 112 can receive a value in a first floating-point number format.

At step 404 one or more of the systems described herein identify a second number format from the plurality of number formats having a second floating-point precision different than the first floating-point precision. For example, processing circuit 112 can identify a second floating-point number format that is different from the first floating-point number format.

The systems described herein can perform step 404 in a variety of ways. In some examples, a second floating-point precision of the second floating-point number format can be higher than a first floating-point precision of the first floating-point number format. In some examples, the first floating-point precision can be higher than the second floating-point precision.

At step 406 one or more of the systems described herein select a processor instruction for converting from the first number format to the second number format. The processor instruction can be selected from a processor instruction set that includes processor instructions for converting between each pairing from amongst the plurality of number formats. For example, processing circuit 112 can select (e.g., via decoding) conversion instructions 114, which can be selected from a processor instruction set of processor 110 and/or processing circuit 112 that includes processor instructions for converting between each pairing of floating-point number formats supported by processor 110 and/or processing circuit 112. The processor instruction set can include processor instructions for converting between variations of floating-point number formats of a similar floating-point precision as well as converting between floating-point number formats of different floating-point precisions.

At step 408 one or more of the systems described herein convert, using the selected processor instruction, the value to the second number format. For example, processing circuit 112 can convert, using conversion instructions 114, the value to the second number format.

The systems described herein can perform step 408 in a variety of ways. In some examples, the processor instruction is further configured to apply a rounding scheme for converting values from the first number format to the second number format.

In some examples, processing circuit 112 can continue with a processing workflow. For instance, processing circuit 112 can process the value in the second number format to produce an output value in the second number format and convert, using a processor instruction (e.g., conversion instructions 114) configured to convert values from the second number format to the first number format, the output value to the first number format. Processing circuit 112 can output the converted output value.

As detailed above, in machine learning contexts, conversion of formats can be a common operation. For example converting from FP8/BF8 to FP32 and converting values back to FP8/BF8 is common for compatibility reasons. In addition, when systems integrate or interface with components from vendors using different floating-point or other data value formats, can be required. Although converting values from one format to another can become a common enough operation, it is often not supported or contemplated to be supported for inter-device compatibility. In addition, values can be operated on in high precision such as FP32, but saving/sending the results in FP32 can consume much bandwidth. Even if values can be operated on quickly, the memory bandwidth can create a bottleneck.

The systems and methods described herein provide improved performance for the conversion process as well as a more accessible process for converting values into different formats. The systems and methods provided herein allow for a new, separate dedicated instructions for the purposes of converting values to a specific format. The conversion process can also include a rounding scheme (such as stochastic rounding) as needed. By using a separate instruction, the systems and methods described herein also allow implementing a desired rounding scheme when needed for the conversion process, such as rounding schemes different from what is often used.

In addition, the systems and methods provided herein further allow conversions for multiple different formats as needed or desired for an architecture. For example, operating in one format (FP32) for desired precision, and converting to another format (FP8) for improved bandwidth reasons, can alleviate potential bottlenecks.

As detailed above, the computing devices and systems described and/or illustrated herein broadly represent any type or form of computing device or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processing circuit configured to:
select, in response to receiving a value in a first number format of a plurality of number formats, a processor instruction comprising micro-operations for converting from the first number format to a second number format of the plurality of number formats, wherein the processor instruction is selected from a processor instruction set including processor instructions for converting between each pairing from amongst the plurality of number formats; and
convert, using the selected processor instruction, the value from the first number format to the second number format.

2. The device of claim 1, wherein the processing circuit is further configured to apply a rounding scheme during the conversion.

3. The device of claim 2, wherein the processor instruction includes the rounding scheme.

4. The device of claim 2, wherein the processing circuit applies the rounding scheme during a conversion from a higher-precision number format to a lower-precision number format.

5. The device of claim 1, wherein the conversion is used in a processing workflow for an operation.

6. The device of claim 5, wherein the processing workflow includes:
performing the operation using the value in the second number format;
converting a result of the operation from the second number format to the first number format; and
outputting the converted result in the first number format.

7. The device of claim 6, wherein converting the result of the operation from the second number format to the first number format includes using a second processor instruction.

8. The device of claim 6, wherein the second number format has a higher floating-point precision than a floating-point precision of the first number format.

9. The device of claim 1, wherein a floating-point precision of the first number format differs from a floating-point precision of the second number format.

10. A system comprising:
a memory;
a processor; and
a processing circuit comprising a processor instruction set including processor instructions for converting between each pairing from amongst a plurality of number formats, the processing circuit configured to:
select, in response to receiving a value in a first number format of the plurality of number formats, a processor instruction from the processor instruction set for converting from the first number format to a second number format of the plurality of number formats, wherein the first number format has a first floating-point precision and the second number format has a second floating-point precision different than the first floating-point precision; and
convert, using the selected processor instruction, the value from the first number format to the second number format.

11. The system of claim 10, wherein the second floating-point precision is lower than the first floating-point precision.

12. The system of claim 11, wherein the processing circuit is further configured to apply a rounding scheme during the conversion and the processor instruction includes the instructions for applying the rounding scheme.

13. The system of claim 10, wherein the processor instruction is used in a processing workflow for an operation, and the processing workflow includes:
performing the operation using the value in the second number format;
converting a result of the operation from the second number format to the first number format; and
outputting the converted result in the first number format.

14. The system of claim 13, wherein converting the result of the operation from the second number format to the first number format includes using a second processor instruction.

15. The system of claim 13, wherein the second floating-point precision is higher than the first floating-point precision.

16. A method comprising:
receiving a value in a first number format of a plurality of number formats, the first number format having a first floating-point precision;
identifying a second number format from the plurality of number formats having a second floating-point precision different than the first floating-point precision;
selecting a processor instruction for converting from the first number format to the second number format, wherein the processor instruction is selected from a processor instruction set including processor instructions for converting between each pairing from amongst the plurality of number formats; and
converting, using the selected processor instruction, the value to the second number format.

17. The method of claim 16, further comprising:
processing the value in the second number format to produce an output value in the second number format;
converting, using a second processor instruction configured to convert values from the second number format to the first number format, the output value to the first number format; and
outputting the converted output value.

18. The method of claim 17, wherein the second floating-point precision is higher than the first floating-point precision.

19. The method of claim 16, wherein the first floating-point precision is higher than the second floating-point precision.

20. The method of claim 19, wherein the processor instruction includes a rounding scheme and the processor instruction is further configured to apply the rounding scheme for converting values from the first number format to the second number format.
